(19) United States
(12) Patent Application Publication
(10) Pub. No.: US 2016/0049089 A1
(43) Pub. Date: Feb. 18, 2016

(54) METHOD AND APPARATUS FOR TEACHING REPETITIVE KINESTHETIC MOTION

(71) Applicant: James WITT, Sedona, AZ (US)

(72) Inventor: James WITT, Sedona, AZ (US)

(21) Appl. No.: 14/775,279

(22) PCT Filed: Mar. 13, 2014
(86) PCT No.: PCT/US14/25743

§ 371 Date: Sep. 11, 2015

Related U.S. Application Data
(60) Provisional application No. 61/956,580, filed on Jun. 11, 2013.
(60) Provisional application No. 61/854,969, filed on May 6, 2013.
(60) Provisional application No. 61/851,953, filed on Mar. 13, 2013.

(51) Int. Cl. G09B 19/00; G09B 5/02

(52) U.S. Cl. CPC G09B 19/003; G09B 5/02; G09B 19/0038

(57) ABSTRACT

Software may be used to train a person's movements (e.g., in sports, in training, etc.) by displaying a first recording and a real-time video of a user. The first recording may relate to a motion of an ideal subject, where a first set of points are identified on the ideal subject's body throughout the motion. The video of the user may be displayed while playing the first recording, where a second set of points are identified on the user's body throughout the user's motion. An indication may be provided to the user when a position of one or more of the first set of points corresponds with a position of one or more of the second set of points.

### CROSS-REFERENCE TO RELATED APPLICATIONS

The present application claims the benefit of priority to U.S. Provisional Patent Application No. 61/851,953 filed on Mar. 13, 2013, U.S. Provisional Patent Application No. 61/854,969 filed on May 6, 2013, and U.S. Provisional Patent Application No. 61/956,580 filed on Jun. 11, 2013, which are all incorporated herein in their respective entireties.

### BACKGROUND

People enjoy learning various skills, such as playing golf. Also, people sometimes wish to learn skills for work, such as physical therapy or other training. However, skill levels vary and it is difficult for people to learn these skills.

One-on-one training from an expert is the only possible solution to improve or learn certain motions. However, it takes a long time for a user to learn motions of experts and there is no real-time feedback. Many times, people will attempt mimic motions of the experts but never can actually learn the skills of the experts because the users are not accurately copying the motions of the expert. The users have no way of learning the skills to the level that is required or desired.

Thus, many users get frustrated and never actually learn the skills as desired. Therefore, the user experience or learned skills are not optimal.

### SUMMARY

The present disclosure relates to utilizing software to train a person's movements (e.g., in sports, in training, etc.). This may be done by comparing the joints of the user with the joints of an expert in real time throughout the motion of the user's motion. Such comparison may be displayed to the user in real time to provide real-time feedback to the user so that the user can immediately correct the user's motions to match the expert's motions. The speed and accuracy of feedback allows the user to solve the above problems according to some embodiments. Various embodiments are described herein.

In one aspect, a first recording and a real-time video of a user are displayed to the user. The first recording may relate to a motion of an ideal subject, where a first set of points are identified on the ideal subject's body throughout the motion. The video of the user may be displayed while playing the first recording that is overlayed with the user's video of the user, where a second set of points are identified on the user's body throughout the user's motion. An indication may be provided to the user when a position of one or more of the first set of points of the user corresponds with a position of one or more of the second set of points of the ideal subject.

According to another aspect, a system a computer hardware processor may include a display and memory. The computer hardware processor displays a first recording, the first recording relating to a motion of an ideal subject, where a first set of points are identified on the ideal subject's body throughout the motion; concurrently displays an video of a user while displaying the first recording, the video relating to a motion of the user, where a second set of points are identified on the user's body throughout the user's motion; and provides, using a computer, an indication to the user when a position of one or more of the first set of points corresponds with a position of one or more of the second set of points.

Various other embodiments are described below and the present invention should not be limited to above-discussed embodiments or specific features of each of the described embodiments.

### DESCRIPTION OF DRAWINGS

Aspects of the present invention is further described in the detailed description which follows in reference to the noted plurality of drawings by way of non-limiting examples of embodiments of the present invention in which like reference numerals represent similar parts throughout the several views of the drawings and wherein:

FIG. 1 illustrates a system of learning kinetic movement according to one embodiment.

FIG. 2 illustrates a golfer with a first set of points according to one embodiment.

FIG. 3 illustrates an ideal subject golfer with a second set of points according to one embodiment.

FIG. 4 shows dots of a first set of points not aligned with dots of a second set of points according to one embodiment.

FIG. 5 shows dots of a first set of points aligned with dots of a second set of points according to one embodiment.

FIG. 6 shows some dots of a first set of points not aligned with dots of a second set of points while other dots are aligned according to one embodiment.

FIG. 7-15 shows dots of a first set of points aligned with dots of a second set of points according to one embodiment.

FIG. 16 shows a flow chart for the software programming of golf training for the user according to one embodiment.

FIG. 17 shows a flow chart for the software programming of an embodiment of golf for recording.

FIG. 18 shows a flow chart of the software programming for another embodiment for training the user.

FIG. 19 shows a flow chart of the software programming for other embodiments for recording.

### DETAILED DESCRIPTION OF SOME EMBODIMENTS

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As used herein, a class may define an abstract characteristic of a thing or object, such as a group of code or instructions for performing a particular operation or function. The abstract characteristics may include characteristics of the thing or object, for example attributes, fields or properties, behaviors, such as functions or methods that can be performed by the class. An object is a particular instance of a class. The set of values of the attributes of a particular object is the state of the object. The object includes the state and the behavior that is defined in the object's class. A method is an object's abilities or functions the object can perform.

In the field of teaching motion, recording an individual's movement such as in golf entailed an analysis of the efficacy of the swing. There was no real time feedback. That is what this present application provides that previously has not occurred. Some methods of teaching kinesthetic activities using software may include recording a user performing a specific movement and recording it via a camera, video recorder, or a motion sensor device such as a Kinect and then he/she or an instructor could analyze the undesirable aspects of the movement. Next, the user could again attempt the desired movement until it was deemed acceptable. That method attempts to teach a kinesthetic movement by pointing out the undesirable aspects of the movement and then discussing it with the user or by showing the user the imperfections. The former uses an auditory approach and the latter utilizes a visual approach. Both teaching techniques are somewhat limited in their efficacy, since a kinesthetic movement is most effectively taught in a kinesthetic manner, in conjunction with auditory and visual aids. As well, analyzing a movement, in particular, noting the negative aspects of the motion, is much less effective than facilitating the user to model a desirable motion in real time, in a kinesthetic manner, and focusing on the desired or if you will the positive aspects of the motion. One embodiment of the invention mitigates or obviates these disadvantages by teaching the user, either independently or with the aid of an instructor, in a kinesthetic manner, in conjunction with auditory and visual means, in real time, the desirable movements.

An embodiment of the invention involves teaching a user where and when to move in order to train his/her muscles. It is based on the principle that after a period of repetitive practice, the automatic or left side of the brain will be programmed to perform at an optimal level in a multiplicity of areas of kinesthetic learning. Research has shown that after a sufficient period of repetitive movement, the left side of the brain will perform movements without complete awareness by the individual—automatically if you will. This occurs in such activities as dribbling a basketball, or kicking a soccer ball, or throwing a football. For example, when a person or quarterback is throwing a football in a competitive game, in order to be effective, he/she is thinking of where the defensive players are positioned, or where his receiver should be in a certain route, not on the technique of throwing a football—that has become automatic. This is true in nearly every kinesthetic activity that a person performs that involves repetitive motion and employs the left side of the brain. Note, that the term left-brain or left side of the brain does not refer to a particular region of the brain, but instead to the way the brain acquires information in a sequential manner. This invention utilizes the unique combination of automatic learning using platforms such as an Xbox or a computer; a motion sensor device such as Kinect or other such motion sensors; and a monitor or wireless glasses or goggles.

An embodiment of the invention records the position in x,y,z coordinates of specific points or joints of a recorded ideal during motion and then highlights them with indicators. It stores that information, and then acquires corresponding data from a user and displays both sets of data simultaneously on a screen so that the user can imitate that motion. By programming the recorded ideal image and the user's image to move in slow motion, the user can follow those precise movements and develop muscle memory that can be applied in real-life situations in a variety of kinesthetic activities. Adding an auditory component that describes each movement in the sequence of an activity reinforces and increases the learning process. Combining the individual learning components of visual, auditory, and kinesthetic (in particular accentuating the kinesthetic aspect) creates a powerful synergy. This invention propels the learning of motion to a more efficient and effective level that previously has not been achieved before.

Definitions According to Some Embodiments

Prior to discussing various embodiments of the present invention, a brief discussion of some of the terms used herein will now be discussed.

The term “dot” may mean a point and may refer to position with an x, y coordinate in two-dimensional space or an x, y, z coordinate in three-dimensional space. Since all geometric figures are comprised of points, when the term points or dots is used it may include all such depictions. For example, a line is a series of infinite points in two dimensions. A plane is an infinite series of points in a three dimensional plane. A line segment is a designated portion of a line. All geometric figures are comprised of points, lines and planes. Therefore, when embodiments of the disclosure alludes to a point or dot, it is simply one representation, it in no way excludes any position, shape, indicator, or representation or any other dot or point. It is all-inclusive in indicating a coordinate. When two or more dots or points are referred to, this can include all points between or on either side of those points since they are included in a common plane. Therefore, there can be no points, shapes, or other forms of visual, auditory, or kinesthetic representations that are outside the claims of this invention, as specified in the next paragraph.

The terms “indicate,” “indicated,” “indication,” “designate,” “designated,” or “designations” may mean something that is able to be seen (visual), heard (auditory), or felt (kinesthetic). The designation of a point or dot may be in any form of indicator visual, auditory, or kinesthetic. Some examples of such visual indicators are shape (for example, but not limited to: triangles, circles, rectangles, hexagons, pentagons, polygons regular and non-regular) size (all range of dimensions depending upon the shape), color (i.e., the visible spectrum, infrared, and ultraviolet), non-color, light graduations (variation in light intensity or luminosity). Auditory indicators refer to any vibration that creates decibels that can be detected by the human ear with or without amplification. For the auditory phase of this invention, the words used in the embodiments as examples, are only that. Embodiments of the invention claims all appropriate teaching phrases for each of the specific activities or sports. Other indicators in the kinesthetic realm include, but are not limited to, vibrations, including any detectable movement by a human being.

The term “motion detectors” may means sensors and accompanying software, either wireless or hardwired devises; other video devices designed for such a task; or cellular devices such as telephones, tablets, or computers in various forms. Sensors may be any device—camera, gyroscopic sensor, gravitational sensor, magnetic sensor any combination thereof, or any other device that collects data and is translated into binary form. Sensors can map points on a person or object through software. Sensors can be used in conjunction with computers to display such data. This disclosure may claim this method in all forms, formats, or versions. When reference is made to SDK or Kinect, embodiments of the disclosure may refer to those specific objects only as a representation of the broader use. SDK is a form of software capture system, however it is only used as an example and can be interchanged with any other viable software capture systems or computer programs as claimed in this invention. Kinect is a specific type of sensor referred to in one embodiment, however it is only an example of a motion senor device and embodiments of the present disclosure may claim the use of any motion capture device.

The term “joint” may refer to a point on an object or a recorded ideal's body or a point on the user's body. A point shown from a sensor is not physically in a joint, but simply represents a position on either side of a joint or an approximation of a joint's position. This can be with x,y,z coordinates or other similar representations. Other designated points on other parts of the body are also considered designated points or may be referred to as joints since they can be used to track movements.

The term “varying speeds” may mean all speeds such as slow motion, real time, faster than real time, and all speeds in between those. Those rates may change depending on the movement the user is learning.

The term “recorded ideal” or “ideal subject” may be interchangeable and may refer to a person who is recorded performing a desired motion that is saved and can later be imitated or mimicked. The recorded ideal may be the user or a person distinct from the user. It should also be understood that the term “ideal subject” may refer to the actual ideal subject person or an avatar representing the ideal subject person.

The term “user” may refer to the person or persons using the end product of the software who mimics the recorded ideal or mimics his/her own recorded movements.

Visual depiction examples defined:

A blue dot is signified by a circle with three diagonal lines angling from the bottom left of the circle to the top right of the circle.

A red dot is signified by a circle with diagonal lines angling from the bottom right of the circle to the top left of the circle.

A purple dot is signified by a circle with vertical lines.

Obviously the present invention is not limited to the above colors but the above colors are used for ease of illustration only. Embodiments of the present invention may use any color combination or any other indicator.

Detailed Description of Some Embodiments

This disclosure relates to teaching a person how to perform a variety of sports and/or activities in an optimal way through muscle memory using software and real-time feedback from the user. Other embodiments involve teaching any motion, and the description of this embodiment in no way limits the scope, and range of the other embodiments claimed.

As previously defined, the term “user” may refer to the person utilizing the software and the term “recorded ideal” or “ideal subject” may refer to the recorded image that the user imitates. The recorded ideal may be the user or another subject displaying a desired movement to be imitated.

One embodiment relates to driving a golf ball in the game of golf which will be referred to herein but the present invention should not be limited to this specific sport.

The system of the present application may include a computing device, a sensor, and a feedback presentation device.

The computing device may include a hardware processor, memory, and computer instructions to perform one or more steps of the methods discussed throughout this disclosure. The memory of the computing device may store the computer instructions which may be called by the processor.

The sensor may be integral with the computing device, such as a camera system that records or displays real-time video of the user, or be separate from the computing device, such as a plurality of wireless sensors that attach to individual joints of the user to communicate real-time positional information back to the computing device for real-time display on the display to the user.

As mentioned above, the wireless sensors may be those that attach to the user's body. Wireless sensors that are both positional and rotational may be employed since there is no occlusion.

Using a visual sensor such, as a camera system (e.g., Kinect), is another embodiment of this invention. Even though some programmable camera systems facilitate a comprehensive video and audio capture, and skeletal detection and tracking, they may be limited in that the subject's torso, legs, and arms must be visible for a few seconds. Some camera systems are hard-wired to approximate specific joints by analyzing human patterns it can see. When portions of the body are obstructed or out of frame, these joints can't be tracked. Additionally, only the pre-listed joints included in some camera systems are available for tracking. Thus, use of some camera systems (e.g., Microsoft Kinect) is simply another embodiment of this invention that may be useful in particular instances.

One embodiment is the use of a first color, a second color, and then a third color. When the first and second colors become proximate within a specified threshold of distance relative to each other, they are considered to be overlapping throughout the matched motions of the user and ideal subject.

One embodiment uses the specific colors of blue, red and purple only for demonstrative purposes, but this does not limit the invention in what type of indictors it claims. Indicators as described are any method or means of distinguishing specific coordinates in order for the user to imitate a movement. For example, different primary colors may be used for the recorded ideal and the user. When the primary colors of the prerecorded image and those of the user overlap during overlaying of the first and second sets of points, the color of the dot that can be seen becomes a distinct third color. For example, if the prerecorded image contains red dots on its joints and the user contains blue joints on his/her corresponding joints, when the user aligns his/her joints with those of the prerecorded image the overlapped joints change to a singular color of purple. The user can then be taught nearly any kinesthetic activity by simply aligning a projection of his/her joints with those of the recorded ideal while the motion of the user is matched with the prerecorded motion of the ideal subject's motion. For each activity particular joints or specified points on the body would be colored and the non-essential joints for that particular activity would be displayed as a neutral color such as gray or black or completely eliminated from view.

The overlaying of the joints of the prerecorded image and that of the user facilitates teaching kinesthetic activities in a very precise and effective manner. This system of overlaying the colored joints of the recorded ideal and that of the user can be utilized not only in motion sensor devises, and hardwired devises that capture the x,y,z, coordinates of the recorded ideal and that of the user, but this method and that which is claimed in this patent facilitates the use of this overlapping method of dots placed on specific parts of the body of the user and the recorded ideal, on film and still images in teaching kinesthetic motions. This method enables teaching the user kinesthetic activities via camera-phones or other video recording devises, and by bundling them with other technologies, such as Bluetooth and other similar devises the user can follow the movements of a prerecorded image in real time.

It should be understood that the first set of points corresponding to motion of the ideal subjects joints are overlayed with the second set of points that correspond to the motion of corresponding joints of the user. This is done for each set of joints of the user. For example, for the shoulder joints of the user, these joints are displayed in a real time manner to the user while the user is going through the motion while simultaneous overlaying the pre-recorded motion of the ideal subject's shoulder joints. This allows the user to align his shoulder joints with the shoulder joints of the ideal subject in real-time using the present system by viewing the indication of the system whether the user's joints align with the ideal subject's joints throughout the motion (e.g., the golf swing). The feedback to the user is instantaneous since the user is viewing instantly whether the user's joints are overlying the ideal subjects joints during the desired motion (in real time).

In an embodiment, slow motion is used to facilitate the effectiveness of this method. When the user is first learning a movement, he/she follows the desired motion at a speed slower than real time until the movement becomes ingrained in the mind. This disclose relates to the use of the overlaying of dots of a recorded ideal and that of a user regardless of the technologies that are currently available or may become available in the future. For example if the joints of the fingers can be mapped or are mapped, and those movements can be recorded, so that such activities entail training a user to perform small motor movement like playing a musical instrument (for example a guitar or piano).

The display of colors may be sketched dots for example or may be lights or other methods of indication of the location and eventual overlap of the dots of the recorded ideal and that of the user. The sequential method of teaching in conjunction with kinesthetic instruction via software relates to another embodiment, such as the repetition of a movement in either super slow motion or slow motion, utilizing the feel of the motion as provided by the mimicking aspect. In addition, some embodiments relate to the method of teaching simultaneous—visual, auditory, and kinesthetic knowledge acquisition as well as the inclusion of left and right brain processing. In each step of the process the user sees, hears, and uniquely feels the movement. The repetition of feeling a particular motion trains the left-brain and subsequent germane muscles of the body. In combination with visual imaging this disclosure creates a unique method of teaching kinesthetic motion. The steps shown as an example are just that.

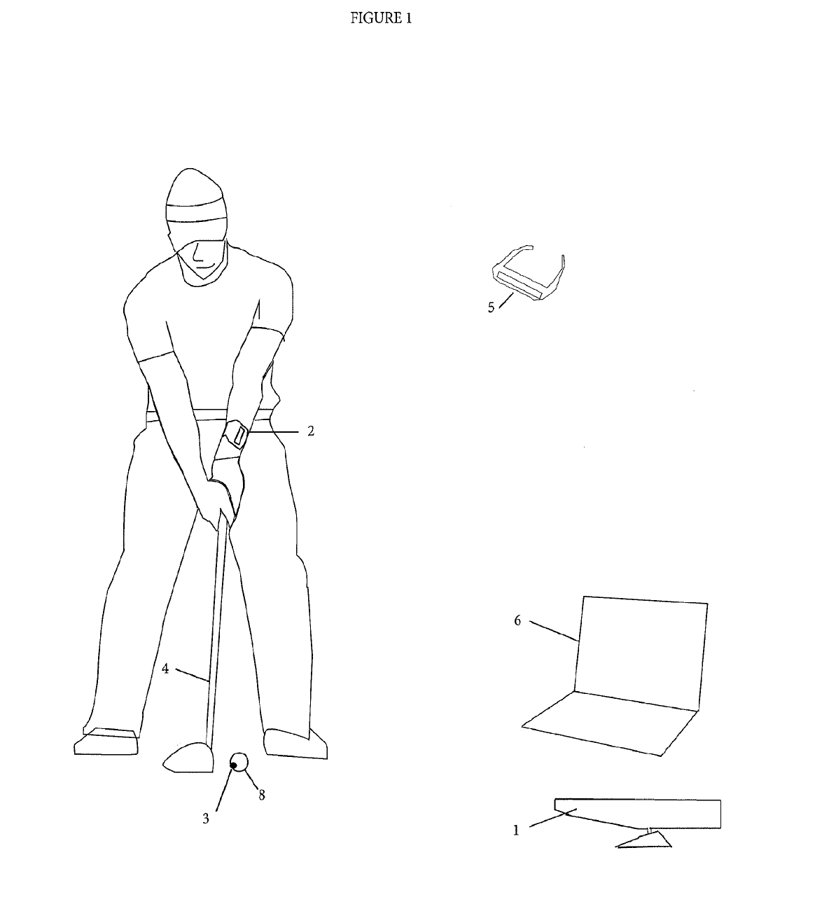

FIGS. 8-15 are examples of how this disclosure functions in its embodiment of teaching a golf swing for driving a golf ball. This disclosure relates to the use of overlaying dots or points of color on all devises and the associated slow motion use of training an individual or user to learn a particular kinetic or kinesthetic movement in a step by step fashion and then applying it to real life situations. This disclosure supplies a method to turn off the critical mind in order to the automatic application of muscle memory to function at a high level in real-life situations. For example in golf, the method involves teaching a golfer to flow energy into his/her limbs, then to transfer the direction of that energy into the black dot 3 FIG. 1, on the ball. By keeping his or her focus on the black dot 3, the critical mind of the user is not feeding negative thoughts into the process, and interfering with the application of muscle memory in the training of the user. Other embodiments of the invention are the use of positive affirmations or directions throughout the teaching process to be used in the sequences shown in FIGS. 8-15. Also, other embodiments may relate to teaching a user to visually track and match his or her dots (or other shapes or indicators) in order to mimic or copy, which enables him/her to feel a desired movement in order to learn a particular kinesthetic activity.

This patent also relates to an additional embodiment in which an athlete or user hits several drives in a real-life situation and those movements are recorded. Then, the best or most desirable of those shots is saved. Later, in slow motion, the user practices that ideal movement in order to train the mind and body to be able to consistently reproduce that motion in real-life situations. For example, if a football player threw twenty passes and three of those twenty were to the standard that the athlete desired, those three would be recorded and played back so the player could match his/her dots with the ideal movements or performance he/she had captured. This might be desirable for an athlete with either unique and or individualized types of movements. This same technique could be used in other embodiments such as physical therapy. The physical therapist would demonstrate a desired motion, perhaps on film and then have the patient mimic that exercise. The physical therapist would guide the patient in moving in the most therapeutic manner, while recording it with the software. The patient would then have access to that recording and in another location such as home, would practice the prescribed precise motion in order to facilitate rapid healing.

Other embodiments for golf are those using a similar method of this invention for fairway woods, irons, chipping and putting. As shown in FIG. 1, the materials may include: a computer 6 (which includes memory and a computer hardware processor), motion sensors 2 that attach to the body of the user, or a Kinect 1; the grip from a golf club or an actual golf club 4, virtual reality goggles 5, and a golf ball 8. Virtual reality glasses or goggles 5, are another embodiment because in some instances of this invention in several activities, they facilitate the user to move his/her head in the most desirable position to perform a movement while viewing the action. However, a monitor placed in an optimal position is one embodiment of this invention since the user must keep his/her head facing the ground (the ball is always on the ground for that activity) and access to a monitor is more universal than goggles. Note, the goggles do allow for nuance for some users with peculiar brain processing styles. During a golf swing if a user was watching a screen it would change the perception since the ball would be where the screen is located. The glasses or goggles would facilitate the person in viewing the action in front of them, but see the ball in the position on the floor where it would normally be. The glasses eliminate any confusion for any type of users in regard to spatial relationships.

An embodiment (the golf swing) begins when the user selects that movement option from the menu and then stands in front of the sensor. The user may be holding an actual golf club or simply the grip from a golf club. The user chooses the body type from a list of recorded ideal golfers or the software picks a similar body type. The software transforms the image of the recorded ideal to that of the user's body. The user waits to be prompted by the software, either visually, or auditorily.

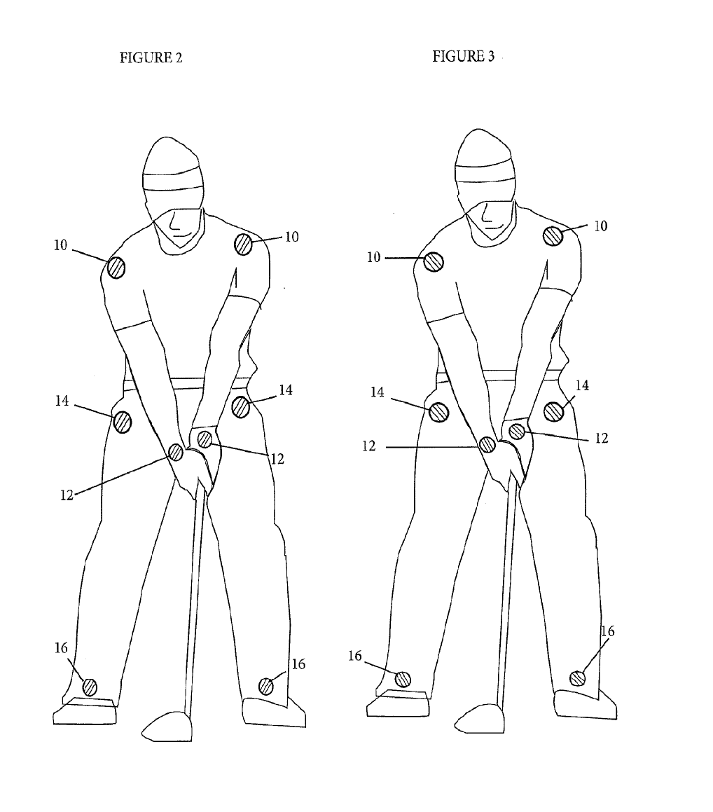

The appropriate joints (shoulders 10, wrists 12, hips 14, and ankles 16) of the recorded ideal are shaded in a first color (for example a primary color such as red) as shown in FIG. 2 according to one embodiment. On the user, the appropriate joints (shoulders 10, wrists 12, hips 14, and ankles 16) are shaded in a second color (for example a primary color such as blue), as shown in FIG. 3. The user can adjust his/her position to align with his/her joints with the recorded ideal golfer or the software can match upon instruction from the user (either verbal or by clicking on a link).

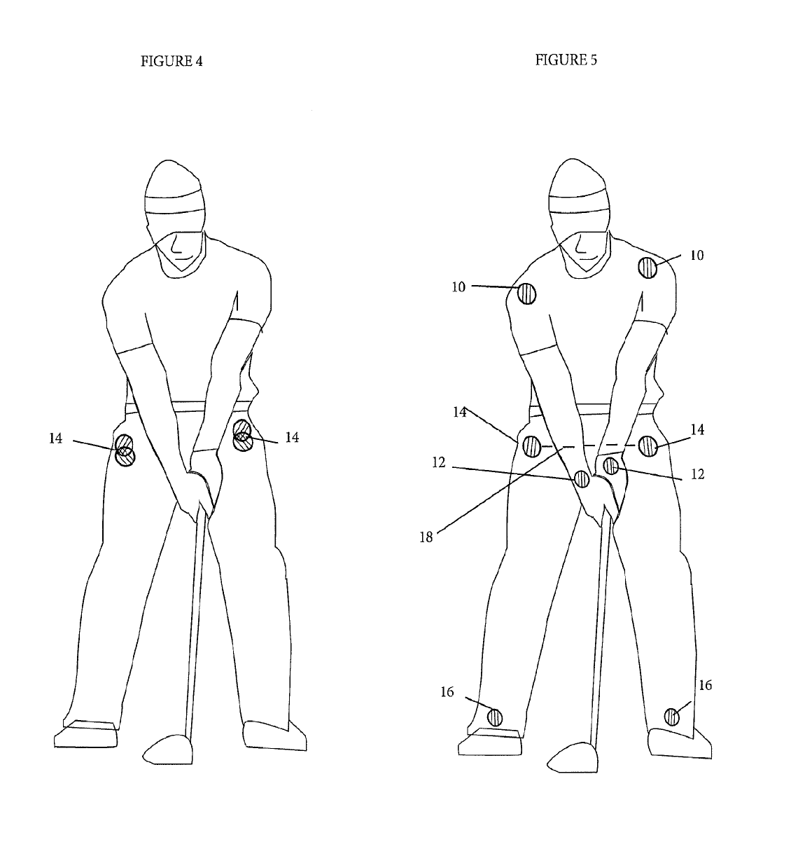

FIG. 4 shows the user in the first sequence where his/her hips 14 are not aligned as both the first color (red) dots and the second color (blue) dots are visible. This allows the user to notice while in motion that the user's joints are not where the recorded ideal's joints were located through the motion.

FIG. 5 shows the user in the first sequence where his/her joints (shoulders 10, wrists 12, hips 14, and ankles 16) are all aligned and so the dots are indicated with a third color (for example a secondary color such as purple).

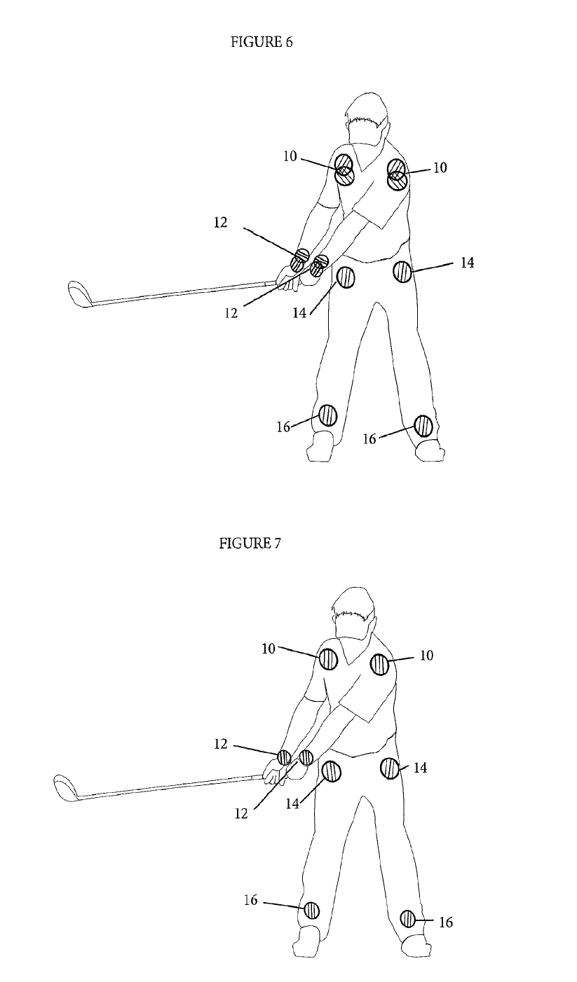

FIG. 6 shows the user in the second sequence where his/her hips 14 are aligned and therefore purple, however the shoulders 10, and wrists 12 are not aligned and so both the blue and red dots are visible.

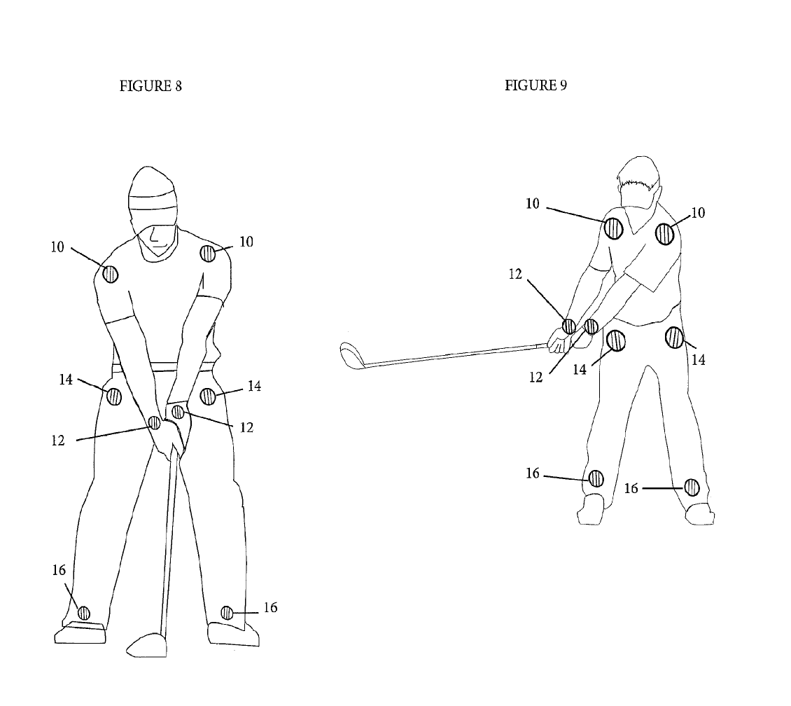

FIG. 7 shows the user in the second sequence where his/her hips 14, shoulders 10, and wrists 12 are aligned properly and so the dots are purple. The recorded ideal golfer moves in slow motion demonstrating the optimal swing as the user imitates the series of movements as shown in FIGS. 8 through 15. Note, that even though slow motion is the speed, other speeds may be used as well. This is facilitated by the colored dots on specific corresponding joints (shoulders 10, wrists 12, hips 14, and ankles 16) of the recorded ideal golfer and the user. Since the dots on the recorded ideal golfer's joints are shaded in blue and the dots on the user's joints are shaded in red, when the user follows the movements in synchronization with the recorded ideal golfer, the dots align and the color of the overlapping dots becomes purple (a secondary color on the color wheel). In other embodiments various colors may be used.

Changing the color of the dots to white when the dots of the user and recorded ideal golfer align is another alternative embodiment. Embodiments of the invention relate to all indicators of position of the x,y,z, coordinates or joint placements; the use of color is only one method. However, the embodiment is to apply a primary color to the recorded ideal recorded ideal golfer's joints such as blue and to apply a primary color to the user's joints, such as red. This method is unique and facilitates the user in following the movements of the recorded ideal golfer since, when the dots align; they form a secondary color such as purple.

FIGS. 8-15 show the complete sequence of the seven steps of the golf swing. Throughout those steps a programmed voice states audibly the key parts of the swing in FIGS. 8-15. This auditory component reinforces the muscle memory and provides the user with key “trigger words” to use when striking an actual golf ball.

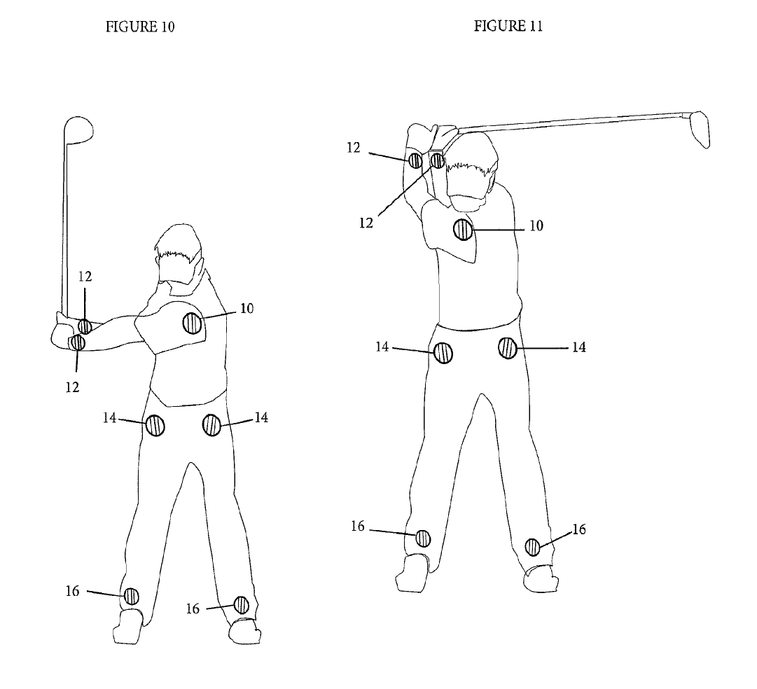

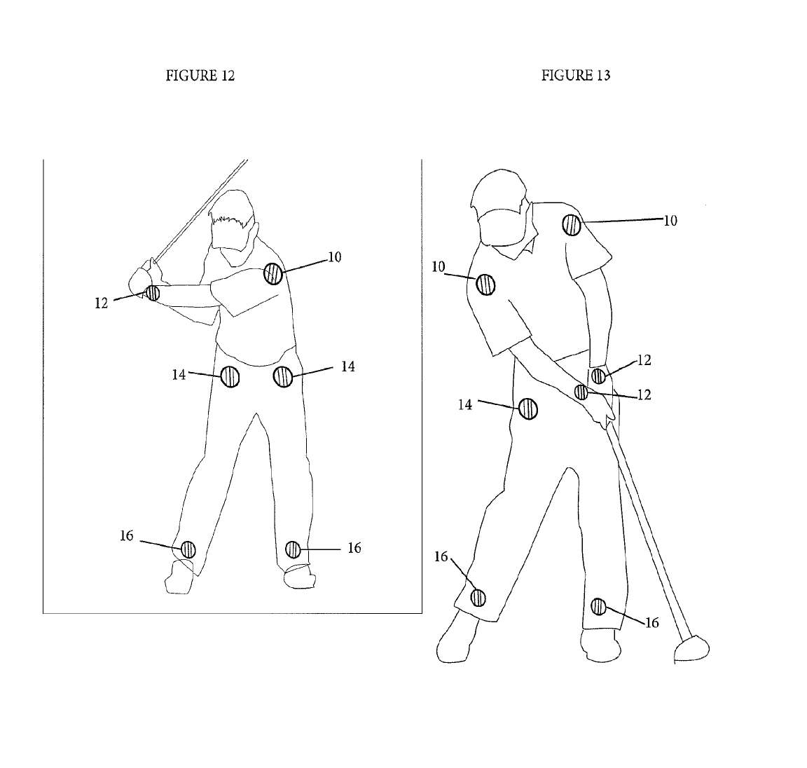

In FIG. 8, a recorded voice says: “hips”. In FIG. 9, a recorded voice says: “shoulders’. In FIG. 10, the recorded voice says: “cock wrists”. In FIG. 11, the recorded voice says: “hips-whoooosh.” The whoosh sound continues throughout FIGS. 13, 14, and 15.

Another embodiment of this invention entails adding an additional level of training as the user becomes more proficient in the swing technique, which is to incorporate a varying type of auditory component. This component would incorporate positive affirmations during the entire sequence. For example, when the user aligns the colored dots, the programmed voice might say: “good”, “perfect”, good job”, “aligned great”. Other embodiments of the audible programmed voice may be to replace the last step in the golf swing with “hips, perfect swing”—drawing out the word “swing” or simply ending with “perfect”—drawing out the word “perfect” to ingrain in the user a positive phrase. When the user is actually playing golf or hitting golf balls the positive affirmation will facilitate producing a good swing. The word “perfect” is just one example among many that may be used for the same purpose of ingraining a positive attitude and thus a result in the swing.

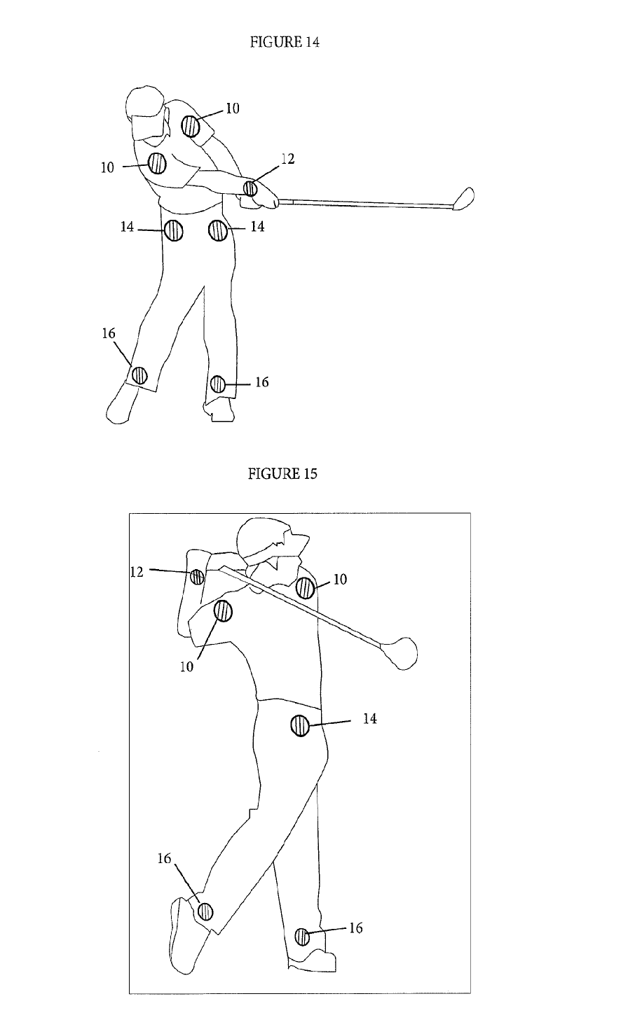

Another embodiment would be to teach the sequence of FIGS. 8-15 in super slow motion. Each of the sequences encompassing FIGS. 8-15 may be broken into individualized segments in order for the user to repeat any single selected portion of the entire swing. More detailed auditory directions would accompany each of the portions. For example: In FIG. 8, the audio might be “the hips begin the backswing, the shoulders follow while the wrists stay quiet”; in FIG. 9—“The hips continue to turn, the shoulders follow and the wrists begin to cock”; in FIG. 10, “The hips are almost completely turned, the shoulders continue to turn, and the wrist continue to cock”; in FIG. 11, “the hips and shoulders are completely turned, and the wrists are fully cocked”, in FIG. 12, “the hips begin the swing by turning toward the ball, the left arm pulls down like ringing a bell”; in FIG. 13, “the left hip dips while approaching impact while the right hip raises slightly”; in FIG. 14, “the eyes continue to focus on the previous position of the ball, keeping your dots aligned with those of the pro”; and in FIG. 15, “continue to align your dots in order to keep them colored purple”.

In addition to the sequence of events, a virtual ball may be shown in the proper position to simulate for the user an object to strike. If the golfer is at a driving range or on a golf course, a real ball should be used. A small black dot 3, as shown in FIG. 1, is marked on the rear hemisphere of the ball near the top.

In another embodiment, the order in which the user is being taught would be to begin with the super slow motion phase. The user repeatedly mimics the movements of the recorded ideal during each individual segment of FIGS. 8-15, until he/she is able to keep his/her dots aligned with those of the recorded ideal. Then, the user is instructed to perform the entire sequence, FIGS. 8-15, in super slow motion. As the user becomes more adept, he/she may increase the speed of the movements to slow motion. The software allows the user to follow the sequence of movements at full speed as well. The user is instructed to perform the series of movements on a regular basis. As the user becomes more adept at keeping the dots aligned during his/her swing, he/she is encouraged to gradually become more focused on the black dot and less on the alignment of the colored dots, since the alignment of the dots will become increasingly more automatic.

After a period of time, approximately three weeks, the user will have trained the appropriate muscles (muscle memory) to enable he/she to practice a golf swing at a driving range or golf course. Once on the course the user is encouraged to use a black marker with water-soluble ink to mark each ball when practicing. The use of the black dot throughout the virtual reality stage, and then when it is used in the actual activity of striking a real golf ball, provides a smooth and effective transition. Also, this method frees the mind from negative thoughts and allows the user to engage the muscles to perform automatically.

When the user focuses on the black dot 3, it quiets the critical mind of the user and often the user will find himself or herself saying the steps in their mind that the automated voice had repeated during their practice using this invention. The mind can only cognitively think of one thing at a time. The mind can alternate from one thought to another quickly but only one at a time. By occupying the mind with positive affirmations, or verbal steps in the swing at specific times, or focusing on a single spot such as the black dot, negative thoughts are overridden. Also, before striking the ball during training and on a driving range or a golf course the user might be instructed to visualize a perfect shot (this might be used as a screen during the virtual training each time before the user goes through the sequence of a swing). Also, the user might be instructed to flow energy like a fire hose through his or her body before beginning the sequence of the swing whether virtually or on a golf course or driving range in order to experience a feeling of relaxed power. Then the user might be taught to flow the energy into the ball as described previously. When the user is being taught the swing, a real golf club, or just the handle of a golf club, or just the joining of the hands as if a club were entwined in the fingers could be used in this invention.

In the embodiment as well as alternative embodiments a “must be level” bar 18, as shown in FIG. 5, may be utilized in the user image and that of the recorded ideal image. This bar 18, adds another dimension of learning to ensure the user has aligned not only the dots, but additionally ensures the user is balanced during he swing, as shown in FIG. 5.

Another embodiment of this invention is recording the user each time he/she uses the invention. This way the user can regularly review his or her progress to realize how well he/she was able to perform the task of following the motions of the recorded ideal by keeping his/her dots aligned. In this program, a voice would audible state positive phrases in those places where the user had aligned the first and second set of points/dots and a secondary color was produced.

Another embodiment of this invention is the incorporation of a virtual golf course. After the user has completed the initial steps of the invention, instead of utilizing the muscle memory learning in the invention on a driving range or golf course, the user can first employ an additional step in the learning process on a virtual golf course. The user would employ the steps of the embodiment, however in addition the user would see the ball resting on the ground of a virtual golf course. When the user completes a sequence and strikes the virtual ball, he/she would see its flight. The preciseness of the alignment of his/her joints with that of the recorded ideal would determine the result of the shot. The speed of the recorded ideal would be increased to real time speed and the user would follow those movements and strike the ball. By showing the results of the flight of the ball, not only does it provide the user with direct feedback, but also as the ball flight improves it provides the user with a visual image of a good shot.

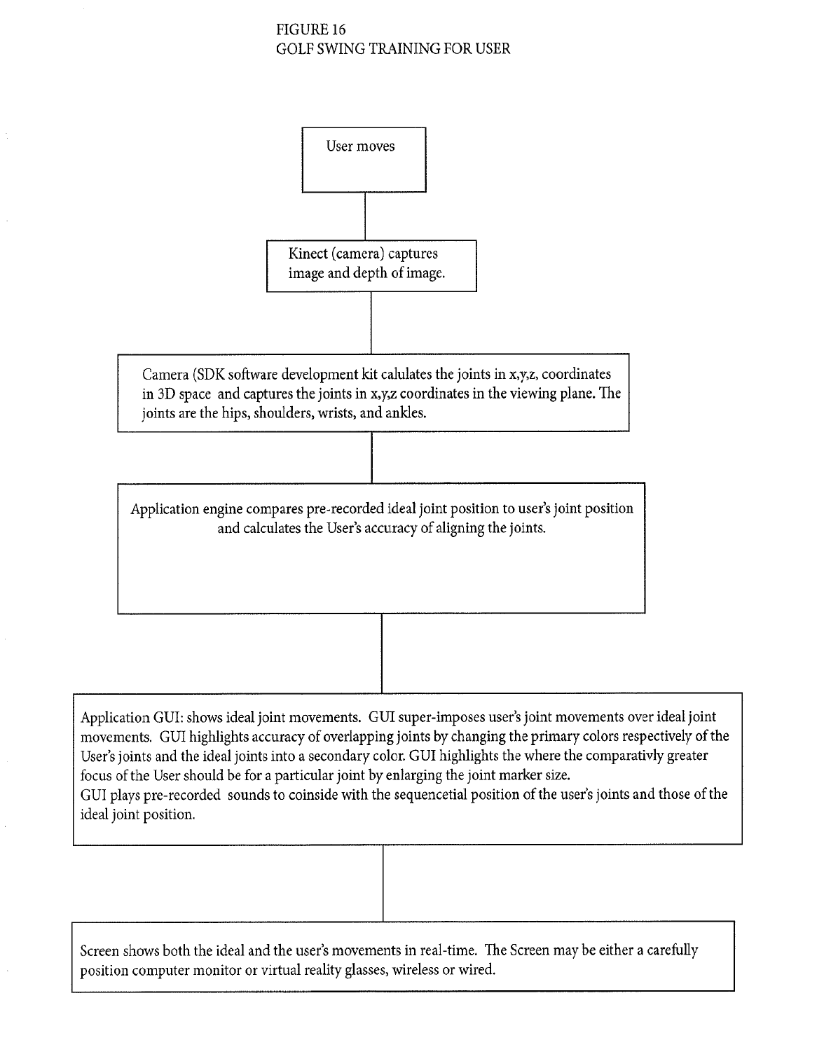

A flow chart of the steps involved in programming the software in golf for the user's muscle memory is shown in FIG. 16. First, the user moves and a camera (e.g., the Kinect) or sensor captures the image and depth of the image of the user. The system may retrieve a previously-recorded recording (e.g., the first recording) of the recorded ideal, where a first set of points is associated with the joints of the ideal subject so that the system understands the movement of the ideal subject's joints throughout the motion (e.g., the Ideal subject's golf swing).

The system then may determine the joint locations of the user and identify a second set of points corresponding to joints of the user so that the system understands the movement of the user's joints throughout the motion (e.g., user's golf swing).

Next the camera or sensor using the software development kit (“SDK”) or other software development platforms, in conjunction with the software of this invention, calculates the x, y, z coordinates of the joints in three-dimensional space as well as capturing the x, y, z coordinates of the joints in viewing space. These coordinates may be stored in a database or the recording itself.

An application engine compares the pre-recorded ideal joint positions (i.e., the first set of points corresponding to the ideal subject's joints) to the user's joint positions (i.e., the second set of points corresponding to the user's joints).

It is noted that each of the first set of points are related to a set of joints of the ideal subject and the second set of points are related to the user's set of joints, where the ideal subject's set of joints each correspond to similar set of joints on the ideal subject. For example, the joints of the ideal user that the first set of points correspond to may be the shoulders, hips and wrists, and as such, the joints for the user that the second set of points correspond to would also be the user's shoulders, hips and wrists, respectively.

As such, the same joints of the user can be matched with corresponding joints of the ideal subject. And, these corresponding joints are recorded throughout at least a portion of the motion of the ideal subject and are recorded/displayed for the user throughout the motion of the user. For example, the motion of each of the ideal subject's joints of a golf swing are determined throughout the golf swing and the motion of the corresponding joints of each of the user's joints of a golf swing are matched (or overlayed) with the ideal subject's joints throughout the user's golf swing.

Referring back to FIG. 16, the application engine calculates the accuracy of the user's set of points. Next, the application's graphical user interface (“GUI”) shows the recorded ideal's joints and superimposes the user's joint movements over the recorded ideal. Then the software color-codes the user's joints in blue and the recorded ideal's joints in red. The application highlights the accuracy by changing the overlapping joints into the third color of purple to simplify the process of aligning joints for the user. Changing the joints to white (or simply removing the colors of the first and second set of points) is another option, as is utilizing other primary colors (or secondary) to produce another color when the joints are aligned.

The software may highlight selected joints by enlarging their size in order to demonstrate the comparative force that should be applied by the user during a particular movement. The GUI application plays pre-recorded sounds. The screen shows both the recorded ideal and user's movements in real time or slow motion time. Either virtual reality glasses or goggles, or a carefully positioned computer screen or monitor may be utilized so the user can view the action.

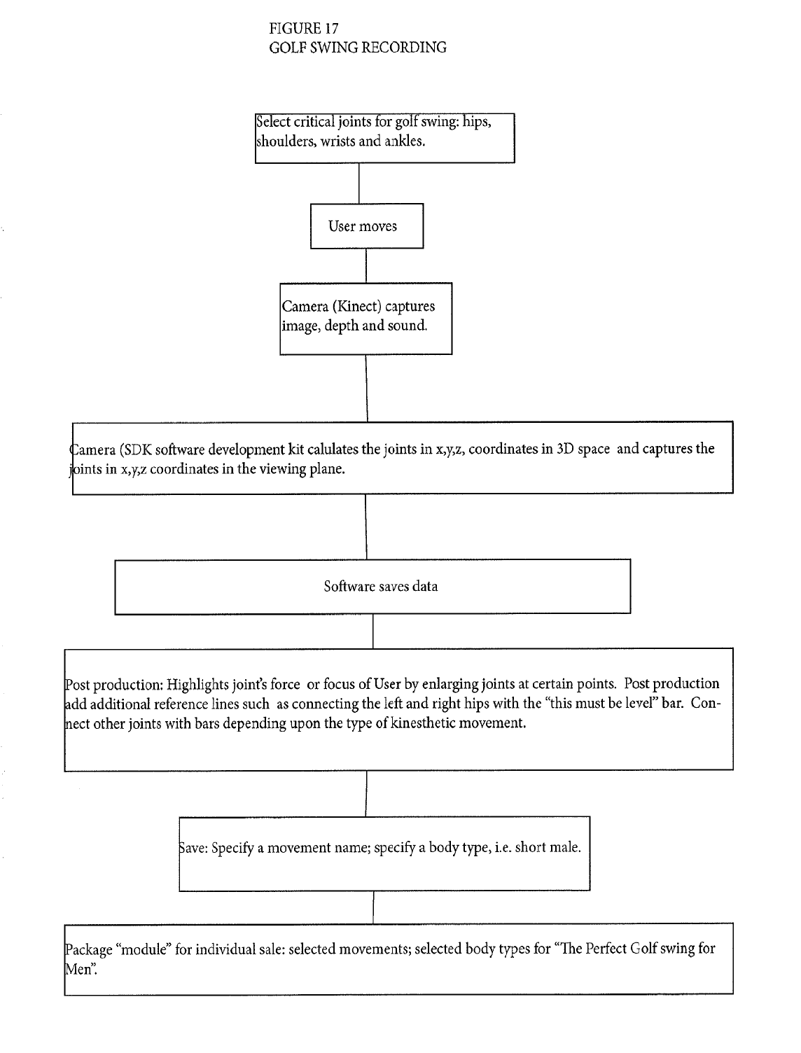

A flow chart of the steps involved in programming the software for the recording of the recorded ideal golfer is shown in FIG. 17. The critical joints for a golf swing are selected such as the hips 14, shoulders 10, wrists 12, and ankles 16. The user moves and then the sensor or camera (Kinect) captures the image, depth, and sound. The software such as SDK calculates the x,y,z coordinates in three-dimensional space. Next, the software such as SDK captures the x,y,z, coordinates in the viewing plane or planes. The software saves the data. Then, in post production, specific joints are highlighted by enlarging them to show where the force or power of the movement is accentuated or centered. Additional reference lines are added as necessary, such as a line connecting the hips using a must level bar 18 as shown in FIG. 5. The information is then saved in order to specify a movement name or specify a body type such as short male or tall female.

Other embodiments include such examples as chipping and putting. Those embodiments just as the embodiment will be packaged for individual sale using selected movements and body types. For example: “The Perfect Golf Swing for Men,” “the Perfect Chip,” or “The Perfect Putt.”

Another embodiment of this invention enables a physical therapist to adjust the range or direction of motion over a period of time thus facilitating the healing process for a patient. As in the golf swing the method utilizes a recording of the user so that the therapist and user can make the necessary adjustments during the therapy process for effective results from the program of therapy. In this embodiment, a programmed voice narrates during the movements and when the user aligns the colored dots with those of the recorded ideal, the voice makes statements of encouragement. As in the golf swing embodiment, the use of verbal feedback improves the quality of the result. Note that in physical therapy, since there is a plethora of exercise, numerous combinations of joints would be shown. The software may allow the therapist or user to toggle on and off the display of specific joints. This limits the number of joints a user must try to match thus eliminating confusion of too much visual information. The x,y,z coordinates of those joints would be located and utilized as described in the embodiment.

The technique of toggling certain joints on or off is another embodiment of this invention that can be applied to all kinesthetic activities. The option of only seeing the essential components of a movement facilitates focus and clarity of the learning experience. It also aids an instructor in teaching a student to be able to focus in on particular aspects of a movement. For example, in golf, the instructor may be directing the attention of the student to the take-away. The hips, wrists and shoulders are the only joints that need to be highlighted. If the ankle joints were visible in that portion of the swing it would only be a distraction since they are not involved.

In other embodiments, using the same system of color-coding or other indicators, a user can be taught a wide range of kinesthetic activities. It should be realized that the above embodiments have described the invention with regard to golf and physical therapy but could be easily applied to any other motion (including any other sport, training activity, etc.). For example: tennis—serving, forehand, backhand, and volley; baseball: fielding, pitching or hitting; basketball: shooting jump shots, shooting free throws, or dribbling; boxing punches- right cross, upper cut, left cross or hook; all martial arts movements (i.e. punches, and blocks) and katas, for example but not limited to: Aikido, karate, tai chi, kempo, kickboxing, jujutsu, judo, kendo, kung fu, taekwondo, and hapkido. Other embodiments of this invention are teaching exercises in a precise manner such as palates, aerobics, yoga, and weight training. Other embodiments include bowling and skiing. As in the embodiment, a similar use of recording the user during sessions that can be played back and reviewed is employed. As well, an audible voice may be utilized in a similar method to the embodiment to improve the outcome by using directions, positive phrases, and affirmations.

As in the golf swing, the black dot 3 may also be used in several of the above-mentioned embodiments, such as the martial arts in which the black dot would be located approximately two inches below the navel of the recorded ideal. That point is called the Hara. Hara and in Oriental philosophy is the location of the intersection of mind, body, and spirit, or the place from which Kiai originates. Kiai is the energy of power in many martial arts. As in the golf swing, the user sees the black dot during the practice of the movements in a martial arts program, however when the user is practicing or performing independently of the invention, he/she visualizes the dot in the Hana and is then able to recall through muscle memory each of the movements as performed using the invention. Another embodiment utilizes virtual venues such as the virtual golf course. A virtual tennis court as well as other appropriate venues that may be typical for individual sports is also included in alternative embodiments of this invention.

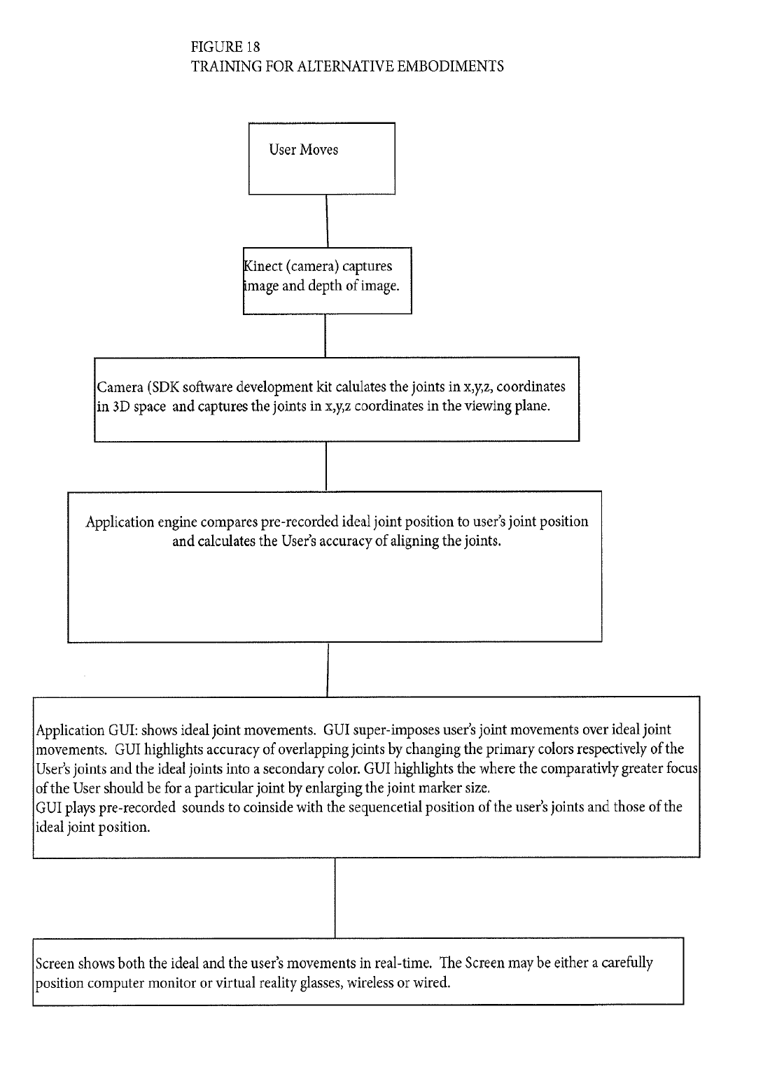

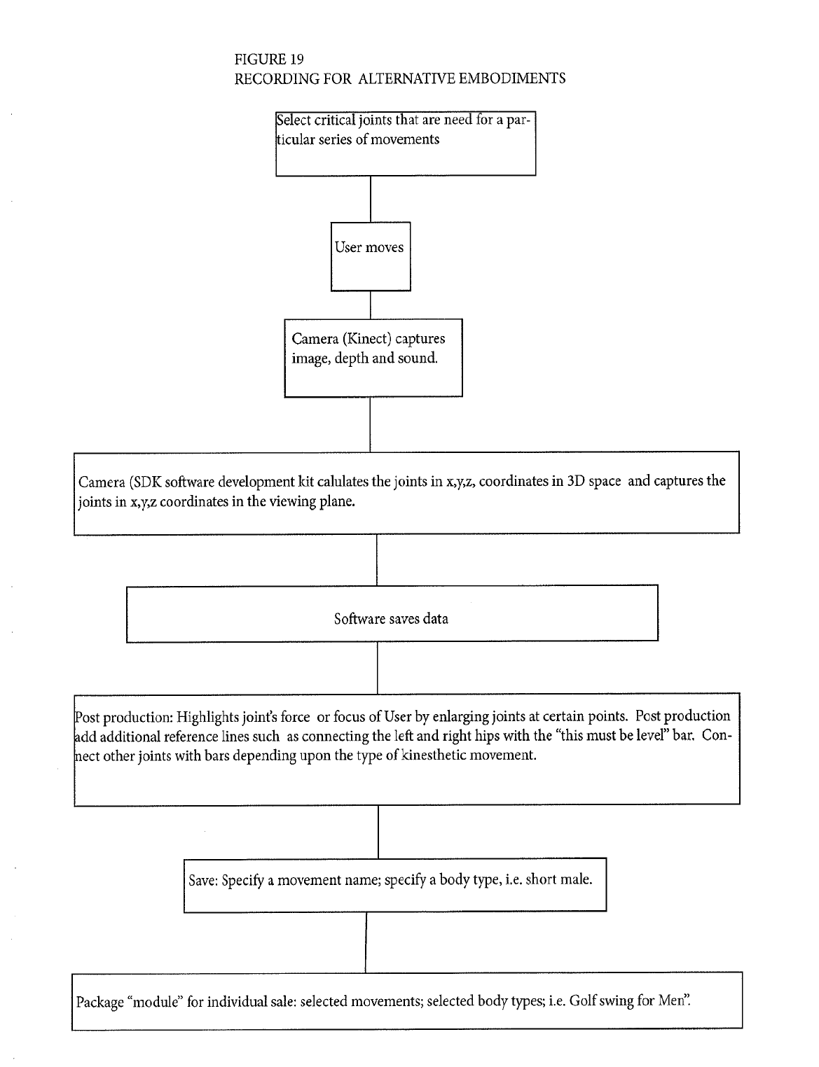

A flow chart of the steps involved in programming the software for the user's muscle memory for any of the other embodiments is shown in FIG. 18. A flow chart of the steps involved in programming the software for the recording of the recorded ideal for alternative embodiments is shown in FIG. 19.

In another embodiment, golf courses from around the world could be photographed or videoed and used. Virtual games of golf between several users could occur and scores could be kept using the method of this invention of aligning of the joints. This same approach could be used for other activities such as tennis when a user could see the result of his/her swing and strike of a virtual ball.

Another embodiment of this invention is the technique of a user recording several of his/her shots in an activity until the optimum shot is recorded and saved. This technique is similar to the embodiment. For example, user would record several tennis shots on a real tennis court, until he/she hit the optimal shot. Then, he/she could use the software to ingrain his/her best swing into his/her mind by mimicking it. That technique as used in tennis or any other kinesthetic motion. Each kinesthetic motion utilizing this technique is another embodiment of this invention. This might best be accomplished using a sensor suit or sensors attached to the user, which are more accurate than camera systems.

Note that many types of motion sensors or hardware platforms could be used to accomplish any of the aforementioned activities. As well, the software development is not limited to the SDK or software development kit for camera systems. For example, other programs could be used such as C# or others. This invention is not limited to any one device or devices.

As well, a green screen and other colored screens in which the recorded ideal golfer might be clothed as that of an avatar are additional embodiments of this invention. In other sports various backgrounds would be used that are apropos to the activity being imitated. The position of the recorded ideal Golfer might be oriented so the user can slide his/he dots from behind in order to make it easy for the user to align his/her joints. If the recorded ideal Golfer were captured from the front then manipulation of the figure might be necessary—such as flipping the image horizontally in order to avoid a mirror image effect that might be confusing to the user. Whereas in physical therapy a mirror image might be preferable for certain exercises. In one embodiment the user would be able to play back each session of an activity such as a golf swing for review and study. In order to incorporate sound into the different activities, time coding might be necessary in order to precisely match the sound and motion appropriately.

Another embodiment would be if a golf pro or instructor were teaching in person. Using the software of this invention, the instructor could specifically adjust the individual joint placements of the student on the recorded ideal and move them into the proper position. This would provide real time instruction.

Another embodiment is one that could be used in several kinesthetic activities such as golf or tennis for example, wherein the user could choose from a screen menu, the length of backswing for a golf or tennis stroke. Since many people have limited mobility due to physical restrictions.

Other embodiments of this invention might entail the option of the user to choose a body type from a comprehensive list of body types so that the user can mimic a recorded ideal that is close in size and shape rather than having the software change the recorded ideal golfers body to the user's body. If well-known golfers were recorded the user could choose a golfer who is closest to his/her own body type, which would motivate the golfer to imitate the swing of his/her favorite or interesting golfer. This embodiment could be utilized for any sport or physical activity; it in no way is limited to golf.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method for teaching repetitive movements comprising:
displaying a first recording, the first recording relating to a motion of a first set of points on a body of an ideal subject, where the first set of points are identified as fixed points on the ideal subject's body and are recorded throughout the motion;
displaying an video of a user while concurrently displaying the first recording, the video relating to a motion of a second set of points of the user's body, where a second set of points are identified as fixed points on the user's body throughout the user's motion;
correlating the first set of points with the second set of points throughout concurrent playing of motions of the ideal subject and the user; and
providing, using a computer, an indication to the user when a position of one or more of the first set of points corresponds with a position of one or more of the second set of points during the concurrent playing of the motions of the ideal subject and the user.

2. The method of claim 1, wherein the concurrently displaying the second recording to the user while displaying the first recording comprises overlaying a first point of the first set of points with a first point of the second set of points.

3. The method of claim 2, wherein the providing an indication to the user comprises indicating when the first point of the first set of points with the second point of the second set of points.

4. The method of claim 1, wherein each of the first set of points indicate are located at joints of the ideal subject and each of the second set of points are located at joints of the user so that the joints of the ideal subject are compared with the joints of the user throughout motion of the user.

5. The method of claim 1, wherein the first set of points of the ideal subject are shown as a first color, wherein the second set of points are shown as a secondary color, and wherein when the position of the first set of points overlaps with the position of the second set of points, a common position of the first and second sets of points is shown as a third color.

6. The method of claim 1, wherein when the position of the first set of points overlaps with the position of the second set of points, the user is alerted of such overlapping for each individual overlapping point.

7. The method of claim 1, wherein when the position of the first set of points overlaps with the position of the second set of points, a new indicator is substituted for the first and second sets of points.

8. The method of claim 1, wherein bone lengths of an image of the ideal subject are changed proportionally to match those of the user.

9. The method of claim 1, wherein the providing the indication to the user occurs throughout one complete movement of the user.

10. The method of claim 1, further comprising:
recording the motion of the ideal subject;
identifying joints of the ideal subject throughout the motion of the ideal subject so that the motion of the joints is identified throughout the motion;
associating the first set of points with joints of the ideal subject so that the joints of the ideal subject are perceivable to the user;
saving the motion as the first recording;
identifying joints of a user; and
associating the second set of points with joints of the user.

11. The method of claim 1, wherein the video of the user is a real-time video and is shown to the user concurrently with the first recording of the ideal subject.

12. A non-transitory computer readable medium embodying computer instructions that, when executed by a computer, performs a method, the method comprising:
displaying a first recording, the first recording relating to a motion of a first set of points on a body of an ideal subject, where the first set of points are identified as fixed points on the ideal subject's body and are recorded throughout the motion;
concurrently displaying an video of a user while displaying the first recording, the video relating to a motion of a second set of points of the user's body, where a second set of points are identified as fixed points on the user's body throughout the user's motion;
correlating the first set of points with the second set of points throughout concurrent playing of motions of the ideal subject and the user; and
providing, using a computer, an indication to the user when a position of one or more of the first set of points corresponds with a position of one or more of the second set of points during the concurrent playing of the motions of the ideal subject and the user.

13. A system comprising:
a computer hardware processor;
a display; and
memory, wherein the computer hardware processor:
displays a first recording, the first recording relating to a motion of an ideal subject, where a first set of points are identified on the ideal subject's body throughout the motion;
concurrently displays an video of a user while displaying the first recording, the video relating to a motion of the user, where a second set of points are identified on the user's body throughout the user's motion; and
provides, using a computer, an indication to the user when a position of one or more of the first set of points corresponds with a position of one or more of the second set of points.

14. The system of claim 13, further comprising, sensors applied to the first set of points on the user such that when the user moves, the sensor captures positional information about the first set of points relative to the body of the user.

15. The system of claim 14, wherein a second sensor calculates specified x, y, and z coordinates on the body of the ideal subject in three dimensional space and displays points in x, y, and z coordinates in a viewing plane, auditory form of discernment, or kinesthetic recognizable arena.

16. The system of claim 14, wherein the sensor calculates specified x, y, and z coordinates on the body of the user in three dimensional space and displays points in x, y, and z coordinates in a viewing plane, auditory form of discernment, or kinesthetic recognizable arena.

17. The system of claim 13, wherein the first and second set of points each are distinguished using a similar, shape, size, color, or light intensity.

18. The system of claim 13, wherein the first set of points of the user are indicated by a color distinct from the second set of points of the ideal subject.

19. The system of claim 13, wherein when the first set of points of the user and the second set of points of the ideal subject overlap within a range of tolerances, the first and second set of points are combined into a third set of points.

20. The system of claim 13, wherein an image of the recorded ideal subject is rotatable by a desirable angle facilitating the ability for the user to overlay his/her corresponding specified points or joints over the corresponding specified points or joints of the ideal subject from an anterior position in order to effectively eliminate mirror image confusion.
